(19) United States
(12) Patent Application Publication
(10) Pub. No.: US 2024/0396123 A1
(43) Pub. Date: Nov. 28, 2024

(54) BATTERY

(71) Applicant: MURATA MANUFACTURING CO., LTD., Kyoto (JP)

(72) Inventors: Takeo ASANUMA, Kyoto (JP); Ippei WAKI, Kyoto (JP)

(21) Appl. No.: 18/792,180

(22) Filed: Aug. 1, 2024

Related U.S. Application Data
(63) Continuation of application No. PCT/JP2023/008892, filed on Mar. 8, 2023.

(30) Foreign Application Priority Data
Mar. 29, 2022 (JP) 2022-054077

(51) Int. Cl. H01M 50/124; H01M 50/103; H01M 50/119; H01M 50/121; H01M 50/128

(52) U.S. Cl. CPC H01M 50/1245; H01M 50/103; H01M 50/119; H01M 50/121; H01M 50/128

(57) ABSTRACT

A battery is provided and includes a battery element, an exterior material that packages the battery element, and a printing layer provided in a state of being exposed on a surface of the exterior material. The exterior material includes a surface protective layer, a barrier layer, and an adhesive layer. The printing layer is provided on a surface of the surface protective layer. A thickness of at least a portion of the exterior material where the printing layer is provided is 60 μm or more and 100 μm or less. The printing layer contains an ultraviolet curable resin, and a thickness from the surface protective layer is smaller than a thickness of the surface protective layer and is 5.1 μm or more.

### CROSS REFERENCE TO RELATED APPLICATIONS

The present application is a continuation of PCT patent application no. PCT/JP2023/008892, filed on Mar. 8, 2023, which claims priority to Japanese patent application no. 2022-054077, filed on Mar. 29, 2022, the entire contents of which are incorporated herein by reference.

### BACKGROUND

The present disclosure relates to a battery.

A battery includes a box-shaped housing portion that houses a battery element. In addition, a laminate film (hereinafter, referred to as an exterior material) may be used as the housing portion. In the exterior material, a surface protective layer, a barrier layer, and an adhesive layer are laminated in this order from the surface. One or a plurality of such exterior materials are bent to form a housing portion having a housing shape (box shape). In the manufacturing process of the battery, after the battery element is housed in the housing portion, a printing layer such as a character or a barcode is provided on the surface of the housing portion. Furthermore, a protective film is adhered onto the printing layer, and the printing layer is covered with the protective film. This protective film is for protecting the printing layer, and has a thickness of 150 μm or less.

### SUMMARY

The present disclosure relates to a battery.

According to the above-mentioned, since the protective film is thick, the battery element is relatively small. That is, the energy density per volume of the battery is small. Therefore, from the viewpoint of increasing the energy density per volume of the battery, it is preferable that a protective film is unnecessary and the thickness of the exterior material is small. On the other hand, in a case where the thickness of the exterior material is 100 μm or less, when a load acts on the printing layer, the shape of the printing layer is transferred to the battery element, and a pressure mark may be generated in the battery element.

In view of the above problems, the present disclosure, in an embodiment, relates to providing a battery that suppresses occurrence of a pressure mark on a printing layer in a battery element while increasing an energy density per volume of the battery.

A battery according to an aspect of the present disclosure, in an embodiment, includes a battery element, an exterior material that packages the battery element, and a printing layer provided in a state of being exposed on a surface of the exterior material. The exterior material includes a surface protective layer, a barrier layer, and an adhesive layer. The printing layer is provided on a surface of the surface protective layer. A thickness of at least a portion of the exterior material where the printing layer is provided is 60 μm or more and 100 μm or less. The printing layer contains an ultraviolet curable resin, and a thickness from the surface protective layer is smaller than a thickness of the surface protective layer and is 5.1 μm or more.

According to the battery of the present disclosure, in an embodiment, the energy density per volume is improved. Further, the battery element has no pressure mark of the printing layer.

### BRIEF DESCRIPTION OF THE FIGURES

FIG. 1 is an enlarged view of a part of a battery according to an embodiment.

FIG. 2 is a sectional view showing a sectional structure of a battery element.

FIG. 3 is a sectional view taken along line III-III in FIG. 1.

### DETAILED DESCRIPTION

The present disclosure will be described in further detail including with reference to the drawings according to an embodiment. The present disclosure is not limited thereto. In addition, components in the following embodiments include substantially the same components, that is, components in a so-called equivalent range. Moreover, the components disclosed in the following embodiment can be suitably combined with each other.

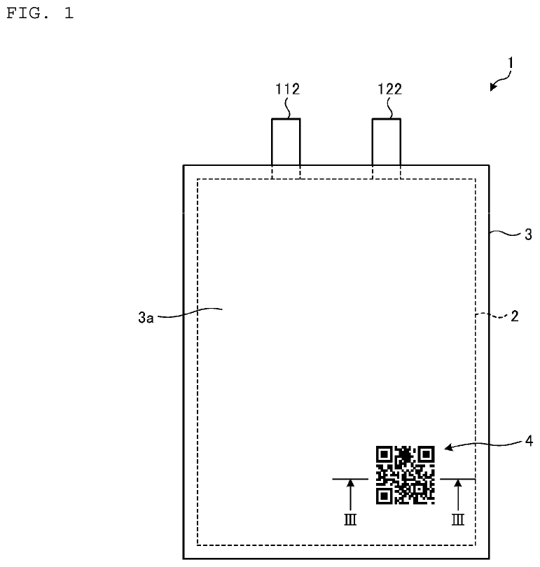

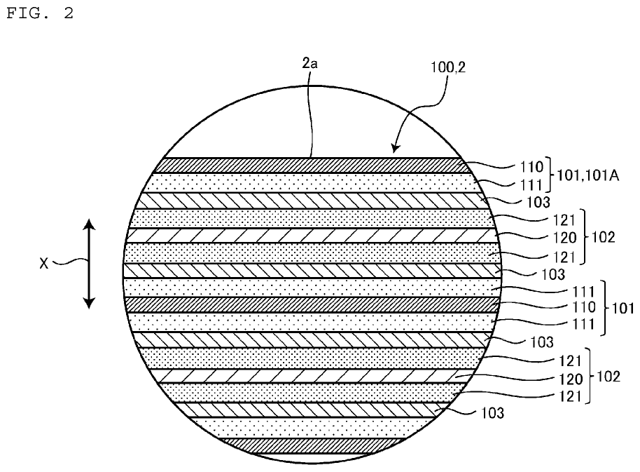

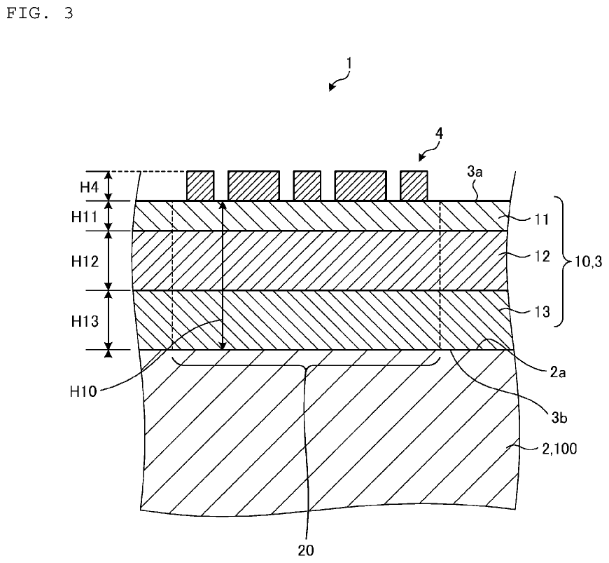

FIG. 1 is an enlarged view of a part of a battery according to an embodiment. FIG. 2 is a sectional view showing a sectional structure of a battery element. FIG. 3 is a sectional view taken along line III-III in FIG. 1. As shown in FIG. 1, a battery 1 includes a battery element 2, a housing portion 3, and a printing layer 4 printed on a surface 3a of the housing portion 3.

The battery element 2 is a lithium ion secondary battery. As shown in FIG. 2, the battery element 2 has a laminated body 100 in which a plurality of positive electrodes 101 and a plurality of negative electrodes 102 are alternately laminated with a separator 103 interposed therebetween. The laminated body 100 is sealed in the housing portion 3 together with an electrolyte (not shown) to constitute a lithium ion secondary battery (battery element 2). The direction in which the positive electrode 101, the negative electrode 102, and the separator 103 are laminated is referred to as a laminating direction X.

The positive electrode 101 includes positive electrode current collectors 110 and a positive electrode active material layer 111. The positive electrode active material layers 111 are provided on both surfaces of the positive electrode current collector 110. However, in a positive electrode 101A disposed on the outermost side in the laminating direction X among the plurality of positive electrodes 101, the positive electrode active material layer 111 is provided only on the surface facing the inner side in the laminating direction X among both surfaces of the positive electrode current collector 110. That is, the surface of the positive electrode 101A facing the outside in the laminating direction X of the positive electrode current collector 110 is not provided with the positive electrode active material layer 111 and constitutes an outer surface 2a of the laminated body 100.

The positive electrode active material layer 111 is not laminated on a part of the positive electrode current collector 110, and the part of the positive electrode current collector 110 is welded to the positive electrode tab 112 (see FIG. 1). The positive electrode tab 112 is drawn out from the inside to the outside of the housing portion 3.

The negative electrode 102 includes a negative electrode current collector 120 and negative electrode active material layers 121. The negative electrode active material layers 121 are provided on both surfaces of the negative electrode current collector 120. Further, the negative electrode active material layer 121 is not laminated on a part of the negative electrode current collector 120, and the part of the negative electrode current collector 120 is welded to the negative electrode tab 122 (see FIG. 1). The negative electrode tab 122 is drawn out from the inside to the outside of the housing portion 3.

The housing portion 3 is a box formed by bending and bonding one or a plurality of exterior materials 10. Therefore, the housing portion 3 includes a plurality of wall portions. As shown in FIG. 3, the exterior material 10 is a film in which a surface protective layer 11, a barrier layer 12, and an adhesive layer 13 are laminated in this order from the surface 3a toward a back surface 3b.

The surface protective layer 11 is a layer for suppressing abrasion due to contact with the outside, and is formed of, for example, a polymer compound such as nylon. The barrier layer 12 is a layer for preventing liquid from entering the inside of the housing portion 3 from the outside, and is formed of, for example, aluminum. The adhesive layer 13 is a layer for adhering to the overlapped portion. The adhesive layer 13 may be a resin material that is melted by heating and cured by cooling, and is formed of, for example, a polymer compound such as polypropylene.

A thickness H10 of the exterior material 10 is 60 μm or more and 100 μm or less in order to improve the energy density per volume of the battery 1. When the thickness H10 of the exterior material 10 is 60 μm, the thickness of each layer is 12 μm for the surface protective layer 11, 24 μm for the barrier layer 12, and 24 μm for the adhesive layer 13. When the thickness H10 of the exterior material 10 is 85 μm, the thickness of each layer is 15 μm for the surface protective layer 11, 35 μm for the barrier layer 12, and 35 μm for the adhesive layer 13. When the thickness H10 of the exterior material 10 is 100 μm, the thickness of each layer is 20 μm for the surface protective layer 11, 40 μm for the barrier layer 12, and 40 μm for the adhesive layer 13.

The printing layer 4 is a two-dimensional code. The printing layer of the present disclosure is not limited to the two-dimensional code, and may be, for example, a bar code of a one-dimensional code. The printing layer 4 is formed of an ultraviolet curable resin. Specifically, a two-dimensional code of an uncured ultraviolet curable resin is molded by a printing machine and transferred to the surface 3a of the housing portion 3. After the transfer, the printing layer 4 is formed by irradiating ultraviolet rays to cure the ultraviolet curable resin. The type of the ultraviolet curable resin is not particularly limited, but an epoxy-based resin is preferable.

Hereinafter, a portion of the housing portion 3 (exterior material 10) where the printing layer 4 is provided is referred to as a laminated portion 20. The back surface 3b of the laminated portion 20 is in contact with the outer surface 2a of the battery element 2. In addition, the thickness H10 of the exterior material 10 is the same in all ranges. That is, the thickness of the laminated portion 20 is the same as the thickness of the portion other than the laminated portion 20. In addition, as described above, the housing portion 3 has a plurality of wall portions, and the printing layer 4 is provided on one of the wall portions. Therefore, the printing layer 4 is not provided on the wall portion located on the back surface with respect to the wall portion provided with the printing layer 4.

When the printing layer 4 is formed on the surface 3a of the housing portion 3, the printing layer 4 protrudes from the surface 3a of the housing portion 3 as shown in FIG. 3. On the other hand, when the battery 1 is assembled in a battery pack or the like, a pressurizing load toward the battery element 2 acts on the printing layer 4. Therefore, when a thickness H4 of the printing layer 4 from the surface 3a of the housing portion 3 is too large, a pressure mark having the same shape as the printing layer 4 is formed on the outer surface 2a of the battery element 2 with the exterior material 10 interposed therebetween. In addition, there is a possibility that any layer of the exterior material 10 is broken. Therefore, the thickness H4 of the printing layer 4 is set to be smaller than a thickness H11 of the surface protective layer 11 in order to avoid generation of a pressure mark and breakage of the layer. Specifically, when the thickness H10 of the exterior material 10 is 100 μm, the thickness H4 of the printing layer 4 is 20 μm or less. When the thickness H10 of the exterior material 10 is 85 μm, the thickness H4 of the printing layer 4 is 15 μm or less. When the thickness H10 of the exterior material 10 is 60 μm, the thickness H4 of the printing layer 4 is 12 μm or less.

On the other hand, when the thickness H4 of the printing layer 4 is too small, for example, information cannot be read by a code reader. From this viewpoint, the thickness H4 of the printing layer 4 is required to be at least 5 μm or more. Further, the surface side of the printing layer 4 (the side of the exterior material 10 opposite to the surface protective layer 11) is not covered at all. That is, the battery 1 does not have a protective film, and the printing layer 4 is exposed. Also from this point, the energy density per volume of the battery 1 is improved.

As described above, according to the battery 1 of the embodiment, a pressure mark is not formed on the battery element 2 if a pressing load acts on the printing layer 4.

Although the thickness of the exterior material 10 of the embodiment is the same in all ranges, in the present disclosure, the thicknesses of the laminated portion 20 and the other portion may be different. When such an exterior material 10 is used, at least the laminated portion 20 of the exterior material 10 may satisfy the above-described thickness (60 μm or more and 100 μm or less).

### Example

Next, an example will be described according to an embodiment. As an example, five batteries 1 were manufactured. The same exterior material 10 was used for housing portions 3 of the five batteries 1. Specifically, as the exterior material 10, one having a thickness H10 of 85 μm was used. The surface protective layer 11 was made of nylon and had a thickness H11 of 15 μm. The barrier layer 12 was an aluminum foil and had a thickness H12 of 35 μm. The adhesive layer 13 was a polypropylene film having a random-block-random three-layer structure with a softening point of 120° C., and had a thickness H13 of 35 μm.

On the other hand, the five batteries 1 were provided with printing layers 4 having different thicknesses H4. The printing layer 4 had the same two-dimensional code. The thicknesses H4 of the printing layers 4 of the five batteries 1 are as shown in Table 1. Hereinafter, the five batteries 1 are referred to as Example 1, Example 2, Example 3, Comparative Example 1, and Comparative Example 2.

TABLE 1

| | | | | | Whether |
|---|---|---|---|---|---|
| | Thickness | | | whether | or not |
| | [μm] of | Thickness | Whether | or not | Pressing |
| | Printing | H4 [μm] | or not | Exterior | Mark is |
| | Layer | of | Printing | Material | Formed on |
| | before | Printing | Layer can | is | Battery |
| | Transfer | Layer | be Read | Broken | Element |
| Example 1 | 10.3 | 9.8 | Enabled | Absent | Absent |
| Example 2 | 8.9 | 8.2 | Enabled | Absent | Absent |
| Example 3 | 5.7 | 5.1 | Enabled | Absent | Absent |
| Comparative | 17.0 | 16.0 | Enabled | Present | Present |
| Example 1 | | | | | |
| Comparative | 3.3 | 3.0 | Disabled | Absent | Absent |
| Example 2 | | | | | |

The thickness H10 of the exterior material 10 used is 85 μm. Therefore, the printing layers 4 having the thickness H4 in the range of 5 μm or more and 15 μm or less correspond to Example 1, Example 2, and Example 3. On the other hand, the printing layers 4 having the thickness H4 that do not fall within the range of 5 μm or more and 15 μm or less correspond to Comparative Example 1 and Comparative Example 2.

Further, the “Thickness H4 of Printing Layer 4” shown in Table 1 is the maximum thickness of the printing layer 4. The printing layer 4 extends along the surface 3a of the housing portion 3, but the thickness thereof is not uniform. When the thickness of the printing layer 4 is large, a pressure mark tends to remain on the battery element 2 when the battery element 2 is pressurized. Therefore, the maximum thickness of the printing layer 4 is shown in Table 1.

The thickness of the printing layer before transfer in Table 1 is the thickness of the uncured ultraviolet curable resin set by a printer. As shown in Table 1, the thickness of the printing layer 4 after being transferred to the housing portion (exterior material) and irradiated with ultraviolet rays was slightly smaller than that before transfer. Test 1 and Test 2 were performed on Example 1, Example 2, Example 3, Comparative Example 1, and Comparative Example 2.

Test 1 tested whether the two-dimensional code of the printing layer 4 could be read with a code reader. The results of Test 1 are as shown in Table 1. The two-dimensional code of Comparative Example 2 (the thickness H4 of the printing layer 4 was 3.0 μm) could not be read. On the other hand, the two-dimensional code of Example 3 (the thickness H4 of the printing layer 4 was 5.1 μm) could be read. The thickness of 5.1 μm of Example 3 is the maximum thickness as described above, and there is a portion having a thickness of less than 5.1 μm in the printing layer 4.

In Test 2, a pressure of 13 kN was applied to the surface of the battery 1 on which the printing layer 4 was provided. The pressurization was performed for 10 seconds. Thereafter, it was confirmed whether or not the exterior material 10 after pressurization was broken by a digital microscope. Further, after confirming whether or not the exterior material 10 was broken, the battery 1 was disassembled, and whether or not there was a pressure mark on the outer surface 2a of the battery element 2 was visually confirmed. The results of Test 2 are as shown in Table 1.

In Comparative Example 1 (the thickness H4 of the printing layer 4 was 16.0 μm), the printing layer 4 was pushed into the exterior material 10, and a part of the exterior material 10 was broken. In addition, it was confirmed that there was a pressure mark on the outer surface 2a of the battery element 2. On the other hand, in each of Example 1, Example 2, Example 3, and Comparative Example 2 in which the thickness H4 of the printing layer 4 was 15 μm or less, the exterior material 10 was not broken, and the battery element 2 had no pressure mark. Therefore, it was found that when the thickness H4 of the printing layer 4 is equal to or less than the thickness H11 (15 μm) of the surface protective layer 11, the exterior material 10 is not broken or has no pressure mark.

### Description of Reference Symbols

1: Battery
2: Battery element
3: Housing portion
4: Printing layer
10: Exterior material
11: Surface protective layer
12: Barrier layer
13: Adhesive layer
100: Laminated body
101: Positive electrode
102: Negative electrode
103: Separator

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising:
a battery element;
an exterior material that packages the battery element; and
a printing layer provided in a state of being exposed on a surface of the exterior material,
wherein the exterior material includes a surface protective layer, a barrier layer, and an adhesive layer,
wherein the printing layer is provided on a surface of the surface protective layer,
wherein a thickness of at least a portion of the exterior material where the printing layer is provided is 60 μm or more and 100 μm or less, and
wherein the printing layer contains an ultraviolet curable resin, and a thickness from the surface protective layer is smaller than a thickness of the surface protective layer and is 5.1 μm or more.

2. The battery according to claim 1,
wherein the surface protective layer is made of nylon, and
wherein the barrier layer is aluminum.

3. The battery according to claim 1, wherein the ultraviolet curable resin is an epoxy resin.

4. The battery according to claim 1,
wherein the battery element includes a laminated body in which a positive electrode and a negative electrode are alternately laminated with a separator interposed therebetween,
wherein the positive electrode includes a positive electrode current collector and a positive electrode active material layer provided on the positive electrode current collector, and
wherein, in the positive electrode disposed on an outermost side in a laminating direction in which the positive electrode and the negative electrode are laminated, the positive electrode active material layer is not provided on a surface that faces outward in the laminating direction among both surfaces of the positive electrode current collector, and the positive electrode active material layer is provided only on a surface that faces inward in the laminating direction.

5. The battery according to claim 1,
wherein a housing portion having a plurality of wall portions is formed of the exterior material,
wherein the printing layer is provided on one of the plurality of wall portions, and
wherein the printing layer is not provided on the wall portion located on a back surface with respect to the wall portion on which the printing layer is provided.
